(19) United States
(12) Patent Application Publication
(10) Pub. No.: US 2004/0002349 A1
(43) Pub. Date: Jan. 1, 2004

(54) Mobile telephone with environment sensor

(75) Inventors: Norikazu Yamagishi, Yokohama-shi (JP); Takaaki Habara, Yokohama-shi (JP); Mutsuharu Takesada, Yokohama-shi (JP); Mina Imai, Yokohama-shi (JP)

Correspondence Address: Christopher J. Fildes, Fildes & Outland, P.C., Suite 2, 20916 Mack Avenue, Grosse Pointe Woods, MI, 48236, US

(73) Assignee: Hitachi Electronic Service Co. Ltd.

(21) Appl. No.: 10/457,772

(22) Filed: Jun. 9, 2003

(30) Foreign Application Priority Data
Jul. 1, 2002 (JP) 2002-191678

(51) Int. Cl. H04Q 7/20

(52) U.S. Cl. 455/456.3; 455/414.1; 455/66.1

(57) ABSTRACT

A mobile telephone with an environment sensor for detecting, analyzing, editing, storing, displaying and transmitting environmental data at necessary locations comprises overall control unit 11, input unit 12, various setup units 121-124, output unit 13, display unit 131, memory unit 14, communication control unit 15, power supply unit 16, environmental data detecting unit 17, environmental data storage unit 18, environmental data analysis unit 19, environmental data abnormality detecting unit 20, environmental data edit/output unit 21, environmental data abnormality warning unit 22, current position acquire unit 23, map data acquire unit 24, environmental data plot unit 25, environmental data transmission control unit 26, and current time acquire unit 27.

### FIELD OF THE INVENTION

The present invention relates to a mobile telephone with an environment sensor.

### DESCRIPTION OF THE RELATED ART

In recent days, mobile telephones are provided with various functions in addition to its primary function concerning communication. Moreover, various environment issues have emerged, and there is increasing demand to develop measures to cope with the situation. In order to develop effective measures and to put them into action, it is necessary to obtain a variety of environmental data at various locations.

### SUMMARY OF THE INVENTION

The present invention aims at providing a mobile telephone equipped with an environment sensor for measuring (detecting) environmental data, the mobile telephone having a function to detect environmental data at necessary locations, and to analyze and edit this data.

In order to achieve the above object, the present invention provides a mobile telephone with an environment sensor comprising an overall control unit, an input unit, an output unit including a display unit, a memory unit, a communication control unit, a power supply unit, an environmental data detecting unit, an environmental data storage unit, an environmental data analysis unit, and an environmental data edit/output unit, the mobile telephone having a function to detect, store, analyze, edit and/or output the environmental data.

Furthermore, the input unit comprises a detection timing setup unit; or a detection timing setup unit and an abnormal value setup unit; or a detection timing setup unit, a transmission timing setup unit, a destination setup unit and an abnormal value setup unit.

Moreover, the mobile telephone comprises an environmental data abnormality detecting unit and an environmental data abnormality warning unit, and having a function to output a warning/alarm and/or display a warning when the detected environmental data and/or the data obtained by analyzing the detected data (analyzed data) exceeds the abnormal value set in advance.

The mobile telephone further has a function to set up the timing for detecting the environmental data and/or the timing for transmitting data to the destination, the timing being selected from during use of said mobile telephone, at a determined time, or at predetermined time intervals.

Furthermore, the mobile telephone comprises: a current positional data acquire unit; or a current positional data acquire unit and a current time acquire unit; or a current positional data acquire unit and a current positional map data acquire unit; or a current positional data acquire unit and a current positional map data acquire unit and a current time acquire unit: the mobile telephone further having a function to acquire the current positional data; or the current positional data and current time; or the current positional data and current position map data; or the current positional data and current position map data and current time; when detecting the environmental data.

The mobile telephone further comprises a function to store a data obtained by adding, to the detected environmental data and/or to the data obtained by analyzing the detected environmental data (analyzed data) and/or to an edited analyzed data, the achieved current positional data; or the current positional data and current time; or the current positional data and current positional map data; or the current positional data and current positional map data and current time.

Even further, according to the current mobile telephone, the current positional data acquire unit comprises a base station positional data acquire unit and a GPS data acquire unit, the mobile telephone having a function to determine at the time of acquiring the current positional data whether a GPS is equipped or not, and if there is a GPS, the current positional data is acquired from the GPS, and if not, the positional data of the base station to which the mobile telephone is connected is acquired automatically.

According further to the current mobile telephone, the current time acquire unit comprises a built-in timer and an external timer acquire unit, the mobile telephone having a function to receive a standard time data from outside when acquiring the current time.

Moreover, when acquiring the current positional map data, the mobile telephone judges whether a map data is stored in the mobile telephone or not, and if there is a stored map data, the map data of the current position is read therefrom, and if there is no stored map data, the map data of the current position is automatically received from a map management center.

Moreover, the mobile telephone has a function to display on the display unit the detected environmental data and/or the data obtained by analyzing the detected data (analyzed data) and/or the edited analyzed data.

Furthermore, the mobile telephone comprises an environmental data map plot unit.

Even further, the mobile telephone has a function to display on the acquired current positional map data the detected environmental data and/or the data obtained by analyzing the detected data (analyzed data) together with the acquired current time.

Moreover, the mobile telephone has a function to store the acquired current positional map data with the detected environment data and/or the data obtained by analyzing the detected data (analyzed data), together with the acquired current positional data; or the current positional data and current time; or the current positional data and current position map data; or the current positional data and current position map data and current time.

The mobile telephone further comprises an environmental data transmission control unit, having a function to transmit the detected environmental data and/or the data obtained by analyzing the detected environmental data (analyzed data) and/or the edited analyzed data to a predetermined destination at either an optional or predetermined timing.

Furthermore, the mobile telephone has a function to add to the detected environmental data and/or the data obtained by analyzing the detected environmental data (analyzed data) and/or the edited analyzed data the acquired current positional data, or the current positional data and current time, or the current positional data and current positional map data, or the current positional data and current positional map data and current time, and to transmit the same to the predetermined destination at either an optional or predetermined timing.

### BRIEF DESCRIPTION OF THE DRAWINGS

FIG. 1 is a block diagram showing the configuration of the mobile telephone with an environment sensor according to a preferred embodiment of the invention;

FIG. 2 is a flowchart showing one example of the initial setup process of the mobile telephone; and

FIG. 3 is a flowchart showing one example of the process for measuring (detecting) environmental data.

### DETAILED DESCRIPTION OF THE PREFERRED EMBODIMENT

The preferred embodiment of the present invention will now be explained with reference to the accompanying drawings.

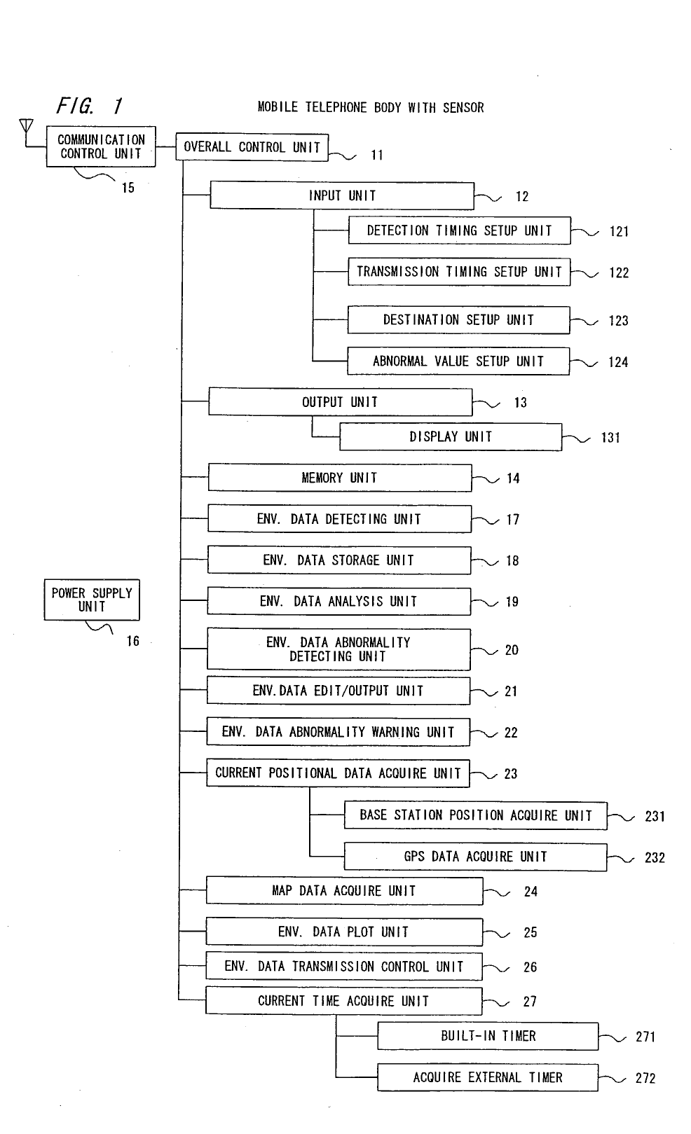

FIG. 1 is a block diagram illustrating the configuration of the mobile telephone with an environment sensor according to the present embodiment.

A mobile telephone 10 comprises an overall control unit 11; an input unit 12 including a detection timing setup unit 121 for detecting the environmental data, a transmission timing setup unit 122 for transmitting various information to a destination (for example, an environment monitor center), a destination setup unit 123 for setting the telephone number and/or mail address of the destination, and an abnormal value setup unit 124 for setting the abnormal value of the detected environmental data and/or analyzed data obtained by analyzing the detected data (hereinafter called analysis data); an output unit 13 equipped with a display unit 131 for displaying various information; a memory unit 14 for storing various information; a communication control unit 15 for communicating with the outside; and a power supply unit 16 for feeding necessary power to the overall mobile telephone.

The mobile telephone 10 further comprises an environmental data detecting unit 17 for detecting environmental data (such as, for example, ozone (UV ray level), photochemical smog, temperature, humidity, air pressure, CO₂, CO, NOₓ, pollen quantity); an environmental data storage unit 18 for storing detected environmental data and/or analyzed data and/or edited analyzed data; an environmental data analysis unit 19 for analyzing the detected environmental data; an environmental data abnormality detecting unit 20 for detecting the abnormality of the detected environmental data and/or analyzed data; environmental data edit and/or output unit 21 for editing/outputting the detected environmental data and/or analyzed data; an environmental data abnormality warning unit 22 for alarming/warning the abnormality of the detected environmental data and/or analyzed data; a current positional data acquire unit 23 including a base station position acquire unit 231 for acquiring the positional information of the base station and a GPS data acquire unit 232 for acquiring the GPS data; a map data acquire unit 24 for acquiring the map data of the current position; an environmental data plot unit 25 for plotting various data on the map information of the current position; an environmental data transmission control unit 26 for transmitting various information to the destination; a current time acquire unit 27 equipped with a built-in timer 271 and an external timer acquire unit 272; and so on.

When measuring (detecting) the environmental data using this mobile telephone, the mobile telephone having the necessary item(s) set up out of the detection timing of the data to be detected, the transmission timing for transmitting data to the destination, the destination address and the abnormal value range is (are) set by setup units 121 through 124 to the mobile telephone. Then, the mobile telephone is brought to the site where environmental data is to be measured, and the telephone is used to detect environmental data at either an optional or preset timing, while also acquiring the current positional data, current positional map data, current time and so on.

Then, the telephone is used to analyze and edit the detected environmental data, and detect abnormal values if any, store necessary data, display necessary data on the screen, put out an alarm/warning if abnormality is detected, and transmits the data to a destination (for example, an environment data monitor center) at either an optional or preset timing.

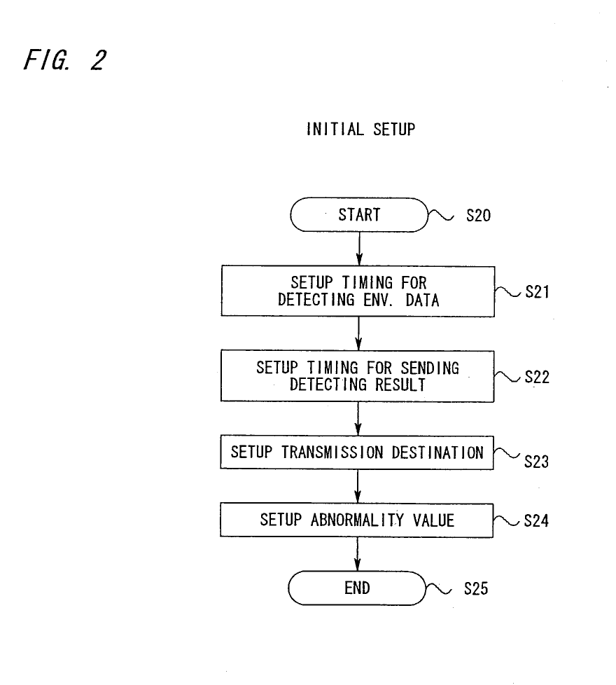

FIG. 2 is a flowchart showing one example of the initial setup of the mobile telephone.

The procedure starts at step S20, and sets up the timing for detecting the environmental data in step S21. The possible options of the detection timing are as follows: at the time of use of (during a call by) the mobile telephone; at a predetermined time; or at predetermined time intervals. In step S22 the timing for transmitting the detected data to a predetermined destination is set up. Similar to the preceding detection timing, the possible options of the transmission timing are as follows: at the time of use of (during a call by) the mobile telephone; at a predetermined time; or at predetermined time intervals.

In step S23, the destination telephone number or destination mail address is set up, in step S24, the abnormal value of the detected data and/or analyzed data is (are) set, and in step S25, the initial setup is completed.

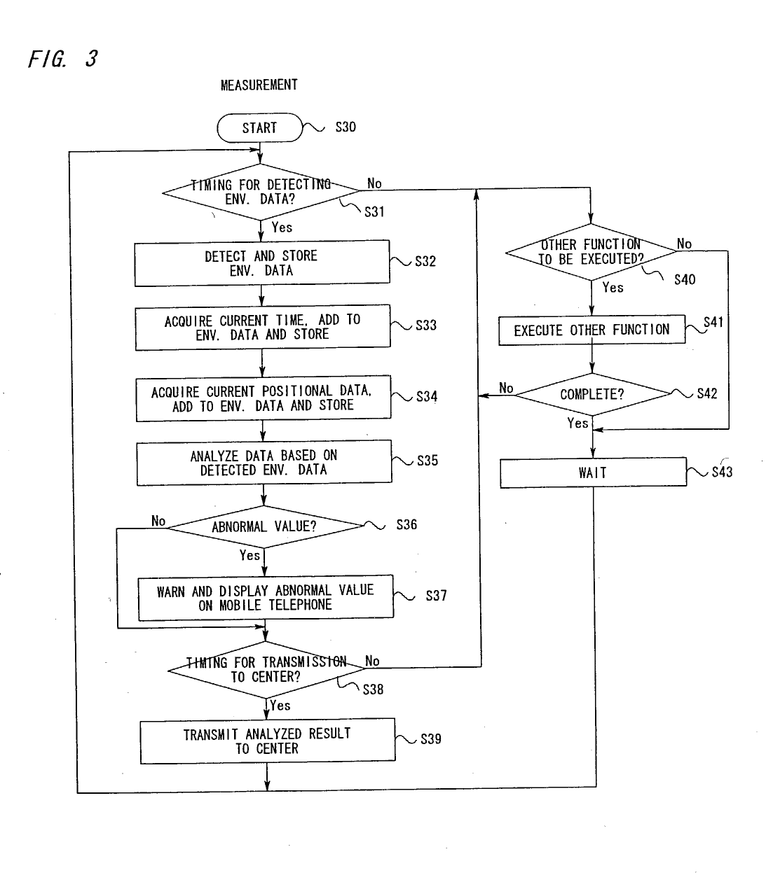

FIG. 3 is a flowchart showing one example of the process for measuring (detecting) the environmental data.

The procedure starts at step S30. In step S31, whether or not it is time to detect a desired environmental data is checked, and if it is time, the desired environmental data is detected and stored. If it is not that timing, the procedure advances to step S40.

The current time is acquired in step S33, which is added to the environmental data and stored in the memory. Further, the current positional data is acquired in step S34, which is added to the environmental data and stored.

Then, in step S35, the detected data is analyzed, and whether the analyzed data exceeds the preset abnormal value or not is checked in step S36. If the data is equal to or above the abnormal value, an alarm or warning is transmitted to the mobile telephone which displays the same instep S37. If the data does not exceed abnormal values, the procedure advances to step S38.

In step S38, whether it is time to transmit data to a predetermined destination (environment information monitor center) is checked, and if it is the transmission timing, the procedure advances to step S39 where data is transmitted to the destination before returning to step S31, and if it is not the transmission timing, the procedure advances to step S40.

Instep S40, whether there is another function to be executed (for example, measurement of other environmental data) is checked, and if there is, that function is executed in step S41. If not, the procedure advances to step S43. When the function is executed, the procedure advances to step S42, and there it is checked whether the execution of the other functions is completed or not, and if completed, the procedure advances to step S43 where it waits before returning to step S31. If it is not completed in step S42, the procedure returns to step S40 to execute other functions.

When displaying and/or storing and/or transmitting to a predetermined destination the detected environmental data and/or analyzed data and/or edited analyzed data, the current positional data acquired at the time of detection of the environmental data; or the current positional data and current time; or the current positional data and the map data of the current position; or the current positional data and the map data of the current position and the present time; can be added to the data.

Moreover, the detection timing of the environmental data and/or the transmission timing of data to the destination can be selected optionally as well as from a preset timing. Further, a warning (alarm) can be output and displayed on a screen not only when the analyzed data shows an abnormal value but also when the detected environmental data exceeds a preset abnormal value.

As explained, the application of the mobile telephone with an environment sensor according to the present invention enables desired environmental data to be detected at various necessary locations. It also enables to acquire present positional data, map data of the present position and current time, to analyze the detected environmental data, to edit the analyzed environmental data, to display the detected, analyzed and/or edited data on a display, to transmit the data to a predetermined destination, to detect abnormality of the detected environmental data and/or analyzed data, and to output an alarm/warning and/or to display the same. Therefore, the present mobile telephone is a very effective environment monitor equipment.

What is claimed is:

1. A mobile telephone with an environment sensor comprising an overall control unit, an input unit, an output unit including a display unit, a memory unit, a communication control unit, a power supply unit, an environmental data detecting unit, an environmental data storage unit, an environmental data analysis unit, and an environmental data edit/output unit, said mobile telephone having a function to detect, store, analyze, edit and/or output the environmental data.

2. A mobile telephone with an environment sensor according to claim 1, wherein said input unit comprises:
a detection timing setup unit; or detection timing setup unit and an abnormal value setup unit; or detection timing setup unit, a transmission timing setup unit, a destination setup unit and abnormal value setup unit.

3. A mobile telephone with an environment sensor according to claim 2, further comprising an environmental data abnormality detecting unit and an environmental data abnormality warning unit, and having a function to output a warning/alarm and/or display a warning when the detected environmental data and/or the data obtained by analyzing the detected data (analyzed data) exceeds the abnormal value set in advance.

4. A mobile telephone with an environment sensor according to claim 2, further having a function to set up the timing for detecting the environmental data and/or the timing for transmitting data to a destination, the timing being selected from the following: during use of said mobile telephone; at a predetermine time; or at predetermined time intervals.

5. A mobile telephone with an environment sensor according to claim 2, further comprising a current positional data acquire unit; or current positional data acquire unit and a current time acquire unit; or current positional data acquire unit and a current positional map data acquire unit; or current positional data acquire unit and current positional map data acquire unit and a current time acquire unit:
said mobile telephone further having a function to acquire the current positional data; or the current positional data and current time; or the current positional data and current positional map data; or the current positional data and current positional map data and current time, when detecting the environmental data.

6. A mobile telephone with an environment sensor according to claim 5, further having a function to store data obtained by adding, to the detected environmental data and/or to the data obtained by analyzing the detected environmental data (analyzed data) and/or to an edited analyzed data, the achieved current positional data, or the current positional data and current time, or the current positional data and current positional map data, or the current positional data and current positional map data and current time.

7. A mobile telephone with an environment sensor according to claim 5, wherein said current positional data acquire unit comprises a base station positional data acquire unit and a GPS data acquire unit, said mobile telephone having a function to determine at the time of acquiring the current positional data whether a GPS is built in or not, and if there is a GPS, the current positional data is acquired from the GPS, and if not, the positional data of the base station to which said mobile telephone is connected is acquired automatically.

8. A mobile telephone with an environment sensor according to claim 5, wherein said current time acquire unit comprises a built-in timer and an external timer acquire unit, said mobile telephone having a function to receive a standard time data from outside when acquiring the current time.

9. A mobile telephone with an environment sensor according to claim 5, further having a function to judge at the time of acquisition of the current positional map data whether a map data is stored in the mobile telephone or not, and if there is a stored map data, the map data of the current position is read therefrom, and if there is no stored map data, the map data of the current position is automatically received from a map management center.

10. A mobile telephone with an environment sensor according to claim 2, further having a function to display on said display unit the detected environmental data and/or the data obtained by analyzing the detected data (analyzed data) and/or the edited analyzed data.

11. A mobile telephone with an environment sensor according to claim 5, further comprising an environmental data map plot unit.

12. A mobile telephone with an environment sensor according to claim 11, further having a function to display on the acquired current positional map data the detected environmental data and/or the data obtained by analyzing the detected data (analyzed data) together with the acquired current time.

13. A mobile telephone with an environment sensor according to claim 11, further having a function to store the acquired current positional map data with the detected environmental data and/or the data obtained by analyzing the detected environmental data (analyzed data) together with the acquired current positional data, or the current positional data and current time, or the current positional data and current positional map data, or the current positional data and current positional map data and current time.

14. A mobile telephone with an environment sensor according to claim 2, further comprising an environmental data transmission control unit, having a function to transmit the detected environmental data and/or the data obtained by analyzing the detected environmental data (analyzed data) and/or the edited analyzed data to a predetermined destination at either an optional or predetermined timing.

15. A mobile telephone with an environment sensor according to claim 14, further having a function to add to the detected environmental data and/or the data obtained by analyzing the detected environmental data (analyzed data) and/or the edited analyzed data the acquired current positional data, or the current positional data and current time, or the current positional data and current positional map data, or the current positional data and current positional map data and current time; and to transmit the same to the predetermined destination at either an optional or predetermined timing.
